(19) United States
(12) Patent Application Publication
(10) Pub. No.: US 2011/0053562 A1
(43) Pub. Date: Mar. 3, 2011

(54) Method and Apparatus for Receipt and Wireless Transmission of a Facsimile

(76) Inventors: Michael R. Self, Fort Lauderdale, FL (US); Raymond J. Penn, Davie, FL (US)

(21) Appl. No.: 12/868,791

(22) Filed: Aug. 26, 2010

Related U.S. Application Data
(60) Provisional application No. 61/236,946, filed on Aug. 26, 2009.

(51) Int. Cl. H04W 4/12

(52) U.S. Cl. 455/412.1

(57) ABSTRACT

A system and method are provided wherein a fax sent to a mobile device, i.e., by faxing to the mobile device's phone number, is stored at a remote server and a textual message informing the user of the stored fax is provided to the user's mobile device.

### INDEX TO RELATED APPLICATIONS

This application claims benefit of U.S. Provisional Application No. 61,236,946, filed Aug. 26, 2009, the disclosure of which is incorporated herein by reference in its entirety.

### DESCRIPTION OF THE RELATED ART

In the past, NOKIA MOBILE PHONES introduced a wireless telephone device with the capability to receive and transmit faxes from the wireless device. The NOKIA 9000 COMMUNICATOR included a received fax folder in which received faxes sent to the device were stored.

U.S. Pat. No. 6,333,973 to Smith et al (“the '973 reference”), issued on Dec. 25, 2001, discloses an integrated message center wherein a fax mail server processes and stores fax mail messages for a user. In the '973 reference, when a caller sends a fax, or fax mail message, to a network services provider for the user, a fax mail server stores the fax at a location corresponding to the user and informs an SMS server of the pending message and the identity and telephone number of the caller. The SMS server then formulates an SMS fax notification message to notify the user of the fax.

What is needed is a system and method for remotely storing a fax, received from a device calling the intended recipient's phone number, and providing the mobile device with the fax formatted for that mobile device.

### SUMMARY OF THE INVENTION

It is accordingly an object of the invention to provide a system wherein a fax sent to a mobile device, i.e., by faxing to the mobile device's phone number or at another phone number that is logically linked to the mobile device's phone number, is stored at a remote server and an informational message informing the user of the stored fax is provided to the user's mobile device. In the instant embodiment, the informational message is used by the mobile device to retrieve the fax, formatted for display on the mobile device.

Other features which are considered as characteristic for the invention are set forth in the appended claims.

Although the invention is illustrated and described herein as embodied in an Method and Apparatus for Receipt and Wireless Transmission of a Facsimile, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

The present invention is illustrated by way of example, and not by way of limitation, in the figures of the accompanying drawing, in which like reference numerals refer to similar elements and in which:

FIG. 1 is a simplified diagram of a system in accordance with one particular embodiment of the instant invention;

### DESCRIPTION OF THE PREFERRED EMBODIMENTS

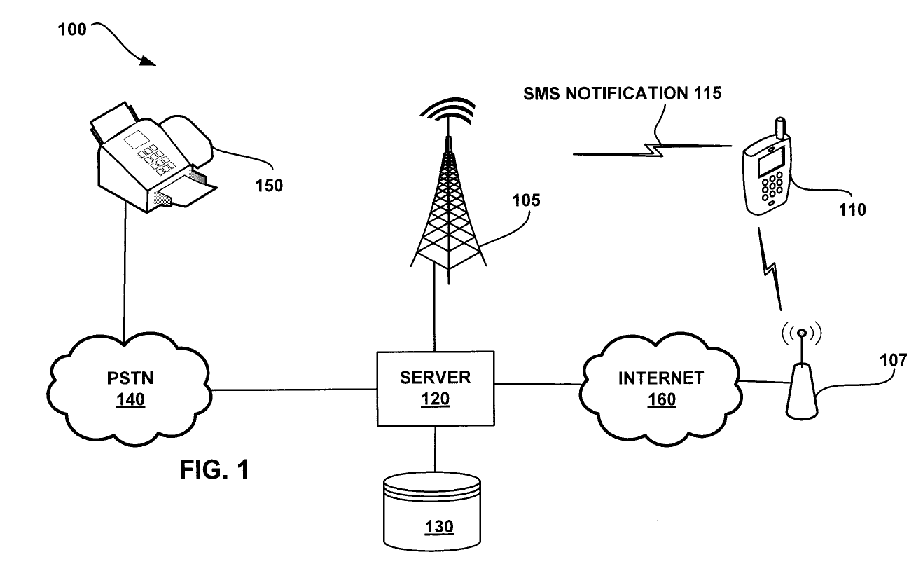

Referring now to FIG. 1, there is shown a simplified diagram of a system 100 for the receipt and transmission of faxes using a mobile device 110. In the system 100, a fax is transmitted by the facsimile transmission device or fax machine 150, which may be a traditional fax machine or transmission device. The fax scanned into the fax machine is transmitted via the public switched telephone network (PSTN) 140. More particularly, in a known way, the user of the fax machine 150 enters into the fax machine 150 a telephone number to which the scanned fax is to be sent. In the instant embodiment of the invention, this telephone number is, in actuality, the telephone number of the recipient's mobile device, i.e., the same telephone number dialed to connect a voice call to the mobile device. In particular, the fax machine 150 dials the entered telephone number corresponding to the recipient mobile device in order to connect over the PSTN 140. It is important to note that there may also exist another telephone number, that when called by fax machine 150 will be associated with mobile device 110. Such another telephone number may be used in place of mobile device 110's telephone number by fax machine 150. In this way, mobile device 110 may not be limited to a telephone but may be a mobile internet device capable of transmitting and receiving data over wireless networks or other devices with similar capabilities that may not have the ability to place or receive telephone calls via the PSTN.

However, in the instant embodiment, rather than the scanned fax being provided to, and stored in, the user's mobile device, the received fax is stored in the fax storage memory 130 by the server 120. Thus, although the fax was transmitted by dialing the telephone number of the mobile device 110, the fax itself is not stored on the user's mobile device 110. One advantage of such a system allows for the remote storage server 120 to store the facsimile data sent by fax machine 150 in a format that preserves certain or all of the characteristics of the original facsimile transmission irrespective of the capabilities of device 110.

Upon receipt and storage of the fax, the server 120 formulates and transmits an informational message, such as a textual message or an SMS message 115, for transmission to the user's mobile device 110, via the mobile network 105. The informational message 115 can inform the user of the receipt of the stored fax and, if desired, can include a hyperlink enabling the user to view the fax stored in the fax storage 130.

In another embodiment, upon receipt and storage of the fax, the server 120 does not send an informational messages to device 110 but rather awaits for device 110 to contact it via a data network at which time server 120 will notify device 110 of the availability of a such received facsimile transmission(s).

Alternately, in one particular embodiment of the instant invention, the mobile device 110 can include software or firmware executable by a processor in the mobile device 110 to intercept the informational message 115 (an SMS message, for example) directly and, using information contained in the message 115 and with or, if desired, without human interaction with mobile device 110, connect to the server 120, via a wireless network 105, to retrieve the fax from the fax storage 130. In the present embodiment, the wireless network 105 can be a wireless cellular network or other type of wireless network, such as, a wireless network connected to the internet using the 802.11 “WiFi” standard, etc.

Additionally, if desired, the mobile device 110 can be provided with a plurality of wireless modems/transceivers, that enable the mobile device 110 to connect wirelessly to a plurality of wireless networks. For example, as particularly shown in the FIGURE, the mobile device 110 is provided with devices that enable it to connect to the server 120 via a wireless cellular network 105 and also via a wireless connection 107 to the Internet 160. The wireless connection 107 can be, for example, a WIFI device, such as can be found at a WIFI hotspot. In such a system, the WIFI capable mobile device 110 would contain the necessary hardware, software and/or firmware to enable the mobile device 110 to communicate with the server 120, via the wireless device 107 and the Internet 160. As such, in response to the receipt of an SMS notification 115, the mobile device 110 can access the Internet via the path wireless Internet path, 107, 160, to access, retrieve and/or review the fax, for example, using a web browser resident on the mobile device 110.

In the presently described embodiment, upon receiving a request from the mobile device 110 to retrieve the stored fax, the server 120 converts the fax to a format appropriate for viewing on the handset 110 (i.e., formattable by the client software running on the handset 110) and/or in accordance with pre-stored preferences of the user. The server 120 then transmits the converted data to the mobile device 110.

Once the fax has been received by the handset 110 it may be optionally stored in memory of the handset 110 for later viewing without the need to access the wireless network 105 again.

Once the fax has been stored in memory of handset 110, it may be manipulated (viewed, deleted, copied, etc.) without need of accessing or affecting the fax image stored on server 120. Indeed, the local copy of the fax residing in handset 110 may be deleted independently of the fax image stored in server 120. This gives the user the maximum flexibility to manage which faxes he chooses to store in memory on handset 110 and which faxes he chooses to store on server 120.

It should be noted that there may also be a coupling of manipulations between handset 110 and server 120; for example, the user may decide that he no longer needs to retain a particular fax on either the handset or the server and he may choose to perform a delete of the fax on the handset 110. Contemporaneously with the deletion of the fax on handset 110, a signal may be sent via wireless network 105 (or wireless network 107, if used) that instructs the server 120 to remove the fax from the fax storage 130, thus eliminating the requirement that a user access two user interfaces (one on the handset 110 and then one on server 120) to manipulate the faxed stored in storage 130.

Conversely, the user may access the fax stored on storage 130 via a web browser or other suitable application via the public Internet 160 to access or manipulate the fax (view, delete, copy, print, forward to another recipient, etc.). Such actions performed via the Internet 160 may then be coupled to handset 110 via one or more signals (such as an SMS message) sent via wireless network 115 that handset 110 may optionally act upon. For example, a user may access server 120 via the public Internet 160, view a fax and then delete it from storage 130. Server 120 may then send a signal to handset 110 via network 115 with instructions to delete the fax from the handset 110's local memory.

The fax can then be viewed on the mobile device 110. If desired, the user of the mobile device 110 can indicate that the stored fax is to be forwarded to another device. In particular, software running in the mobile device 110 can be used to signal the server 120 that the fax should be sent to a dedicated fax machine, for printing, or even to a further mobile device, as desired by the user. For example, the user can enter a command on the mobile device 110 that the fax should be forwarded to the mobile device of another user, which further mobile device may receive the fax formatted differently than the user's mobile device 110. In such a case, the server 120 sends an SMS message to the further mobile device, which is intercepted by software running in that further mobile device, and which retrieves the fax in a appropriate format for the further mobile device. Note that the server 120 may format the fax differently for the mobile device 110 than for the further mobile device, in accordance with the recipient's prestored preferences or, alternatively, in accordance with dynamically determined device capabilities of device 110.

In the instant embodiment of the invention, the telephone number of the mobile device is a multi-purpose telephone number capable of receiving voice calls, as well as fax calls, with the capability of automatically detecting the type of call and then handling the call in the most appropriate manner. For example, in the instant invention, if voice is detected at the mobile device, the call is processed as a voice call and connected by the server 120 to the user's preferred voice communications device. If the call is detected to be a fax, the server 120 automatically receives the fax and formats the fax for disposition in a variety of ways, depending on the end user's pre-stored preferences in a database. For example, the recipient user can pre-inform the server 120 to perform any or all of the following: deliver fax to the mobile device; store the fax in an online “inbox” for the user; email the fax to one or more email addresses pre-stored in a configuration database.

Note that the above-described embodiments are exemplary and that the above invention is not meant to be limited only to its preferred embodiments. It can be seen that other modifications can be made to the preferred embodiments and still be within the spirit of the present invention.

I claim:

1. A system for handling a fax for use by a mobile device, comprising:
a server for receiving a fax transmitted to the telephone number of the mobile device and storing the fax in a fax store;
the server sending an informational message to the mobile device after receipt of the fax;
the mobile device being configured to retrieve the fax from the server over a wireless network, after receipt of said informational message; and
said server formatting the fax for viewing on the mobile device and providing the formatted fax to the mobile device.

2. The system of claim 1, wherein the mobile device is configured to instruct the server to forward the fax to another recipient device.
